(19) United States
(12) Patent Application Publication
(10) Pub. No.: US 2021/0361520 A1
(43) Pub. Date: Nov. 25, 2021

(54) MASSAGING APPARATUS

(71) Applicant: DAITO ELECTRIC MACHINE INDUSTRY COMPANY LIMITED, Higashi-Osaka-shi, Osaka (JP)

(72) Inventors: Koji TAGUCHI, Higashi-Osaka-shi (JP); Tetsuya ISHIKAWA, Higashi-Osaka-shi (JP); Shinsaku SHIMIZU, Higashi-Osaka-shi (JP)

(73) Assignee: DAITO ELECTRIC MACHINE INDUSTRY COMPANY LIMITED, Higashi-Osaka-shi, Osaka (JP)

(21) Appl. No.: 16/982,220

(22) PCT Filed: May 17, 2019
(86) PCT No.: PCT/JP2019/019690

§ 371 Date: Sep. 18, 2020

(30) Foreign Application Priority Data
Aug. 17, 2018 (JP) 2018-153594

(51) Int. Cl. A61H 7/00; A61H 23/00

(52) U.S. Cl. CPC A61H 7/007; A61H 23/006; A61H 2201/0119; A61H 2201/1676; A61H 2201/1418; A61H 2201/1215

(57) ABSTRACT

A massaging apparatus minimizes the application of an excessive load to a massage target area of user's body from a massaging element firmly pressed into contact with the massage target area, provides satisfactory massage treatment, and distributes an excessive load imposed on the massaging element to protect the massaging apparatus itself from damage such as breakage. The massaging apparatus includes a massaging element for performing massage treatment on a massage target area of user's body, and an arm member provided at its head with the massaging element. The arm member has load-reducing mechanism for absorbing a load applied to the arm member from the massaging element. The load-reducing mechanism absorbs a load imposed on the massaging element by exploiting an urgence exerted in a front-rear direction.

### TECHNICAL FIELD

The present invention relates to a massaging apparatus.

### BACKGROUND ART

A massaging apparatus, which incorporates a load-reducing mechanism, has been developed to reduce an overload caused on a massage target area of user's body by a massaging element. The load-reducing mechanism of this conventional massaging apparatus serves also to distribute an excessive load imposed on the massaging element, and thus provides protection for the massaging apparatus itself from damage such as breakage.

A known example of such a load-reducing mechanism-equipped massaging apparatus is disclosed in Patent Literature 1.

For example, Patent Literature 1 discloses a massaging apparatus comprising a massaging element-driving unit 7 having a rotation shaft for kneading massage, a massaging element support constructed of a coil spring attached to the rotation shaft, and a massaging element attached to the free end of the massaging element support. In the massaging apparatus having such a massaging element support, as the massaging element is subjected to a heavy load, the massaging element support in the form of a coil spring becomes resiliently deformed for absorption of the load, thereby reducing a load caused on a massage target area of user's body by the massaging element, so that the massage target area can be moderately pressed by the massaging element.

### PRIOR ART REFERENCE

### Citation List

Patent Literature 1: Japanese Unexamined Patent Publication JP-A 2005-230399

### SUMMARY OF INVENTION

### Technical Problem

The massaging element support provided in the massaging apparatus disclosed in Patent Literature 1 is constructed of a coil spring wound around an axis inclined in a vertical direction to, and in intersecting relation to the rotation shaft for kneading massage having a horizontally directed axis. The coil spring described in Patent Literature 1 is resiliently deformable not only in a front-rear direction but also in a left-right direction, i.e. horizontal direction, and hence absorbs not only a load exerted in the front-rear direction but also a load exerted in the horizontal direction.

In this case, for example, during kneading massage treatment on the massage target area, the coil spring may undergo unnecessary resilient deformation in response to the horizontal rocking motion of the massaging element, which leads to a decrease in massaging force applied to the massage target area. Consequently, the massaging apparatus may fail to achieve satisfactory massage treatment.

By way of example, a massaging apparatus for kneading massage treatment is designed to perform kneading massage treatment on a massage target area of user's body by rocking paired left-hand and right-hand massaging arms in opposite directions to allow the arms to move close to and away from each other, so that a left-hand massaging element disposed at the head of the left-hand massaging arm and a right-hand massaging element disposed at the head of the right-hand massaging arm can hold and release the massage target area lying between them on an intermittent basis. In this construction, the placement of a spring capable of horizontal resilient deformation between each massaging element and the corresponding arm may unduly decrease the force exerted by the massaging elements to hold the massage target area, expressed differently, the intensity of kneading massage treatment (i.e. force of massage).

The present invention addresses the problems discussed above, and aims to provide a massaging apparatus that minimizes the application of an excessive load to a massage target area of user's body from a massaging element which is being firmly pressed into contact with the massage target area, provides satisfactory massage treatment, and is capable of distributing an excessive load imposed on the massaging element to protect the massaging apparatus itself from damage such as breakage.

### Solution to Problem

In order to solve the described problems, the following technical means is adopted for the implementation of a massaging apparatus pursuant to the present invention.

That is, the present invention provides a massaging apparatus comprising a massaging element for performing massage treatment on a massage target area of user's body, and an arm member provided at its head with the massaging element. The arm member has a load-reducing mechanism for absorbing a load applied to the arm member from the massaging element. The load-reducing mechanism is designed to absorb a load imposed on the massaging element by exploiting an urgence exerted in a front-rear direction.

In the present invention, it is preferable to provide a rotatable drive shaft for producing a rotatably driving force, a first arm member extending in a first direction in intersecting relation to the rotatable drive shaft, a second arm member extending in a second direction in intersecting relation to the rotatable drive shaft, a first massaging element disposed at a head of the first arm member, and a second massaging element disposed at a head of the second arm member.

It is preferable that the load-reducing mechanism effects an urgence in the front-rear direction by causing the second arm member to deflect in the front-rear direction.

In the present invention, it is preferable that the second arm member has a thin-walled portion formed at a certain part thereof in a lengthwise direction, and that the thin-walled portion undergoes elastic deformation to yield an urgence.

In the present invention, it is preferable to provide a rotatable drive shaft for producing a rotatably driving force, a first arm member extending in a first direction in intersecting relation to the rotatable drive shaft, a second arm member extending in a second direction in intersecting relation to the rotatable drive shaft, a first massaging element disposed at a head of the first arm member, and a second massaging element disposed at a head of the second arm member.

It is preferable that the load-reducing mechanism, which is disposed between the first arm member and the first massaging element, includes a spring member which is biased about a horizontally directed axis, and a support structure for supporting the arm member for free rocking motion about the rotatable drive shaft.

In the present invention, it is preferable that an urgence of the spring member for the first massaging element is transmitted to the second massaging element via the support structure.

In the present invention, it is preferable to provide a massaging base bearing the first arm member and the second arm member, and a frame body for supporting the massaging base for rocking motion about the rotatable drive shaft at a predetermined rock angle.

### Advantageous Effects of the Invention

The massaging apparatus pursuant to the present invention minimizes the application of an excessive load to a massage target area of user's body from the massaging element which is being firmly pressed into contact with the massage target area, provides satisfactory massage treatment, and is capable of distributing an excessive load imposed on the massaging element to protect the massaging apparatus itself from damage such as breakage.

### BRIEF DESCRIPTION OF DRAWINGS

FIG. 1 is a perspective view showing a massaging apparatus according to a first embodiment of the present invention in a condition where a massage target area of user's body is out of contact with a massaging element.

FIG. 2 is a perspective view showing the massaging apparatus according to the first embodiment in a condition where the massage target area of user's body is firmly pressed in contact with the massaging element.

FIG. 3 is a sectional view of the massaging apparatus according to the first embodiment taken along the axis of a rotation shaft.

FIG. 4 is a side view showing the massaging apparatus according to the first embodiment in a condition where the massage target area of user's body is out of contact with the massaging element.

FIG. 5 is a side view showing the massaging apparatus according to the first embodiment in a condition where the massage target area of user's body is firmly pressed in contact with the massaging element.

FIG. 6 is a perspective view showing a massaging apparatus according to a second embodiment of the present invention in a condition where a massage target area of user's body is out of contact with a massaging element.

FIG. 7 is a perspective view showing the massaging apparatus according to the second embodiment in a condition where the massage target area of user's body is firmly pressed in contact with the massaging element.

FIG. 8 is a sectional view of the massaging apparatus according to the second embodiment taken along the axis of a rotation shaft.

FIG. 9 is a side view showing the massaging apparatus according to the second embodiment in a condition where the massage target area of user's body is out of contact with the massaging element.

FIG. 10 is a side view showing the massaging apparatus according to the second embodiment in a condition where the massage target area of user's body is firmly pressed in contact with the massaging element.

### DESCRIPTION OF EMBODIMENTS

### First Embodiment

An embodiment of a massaging apparatus 1 pursuant to the present invention will now be described in detail with reference to drawings.

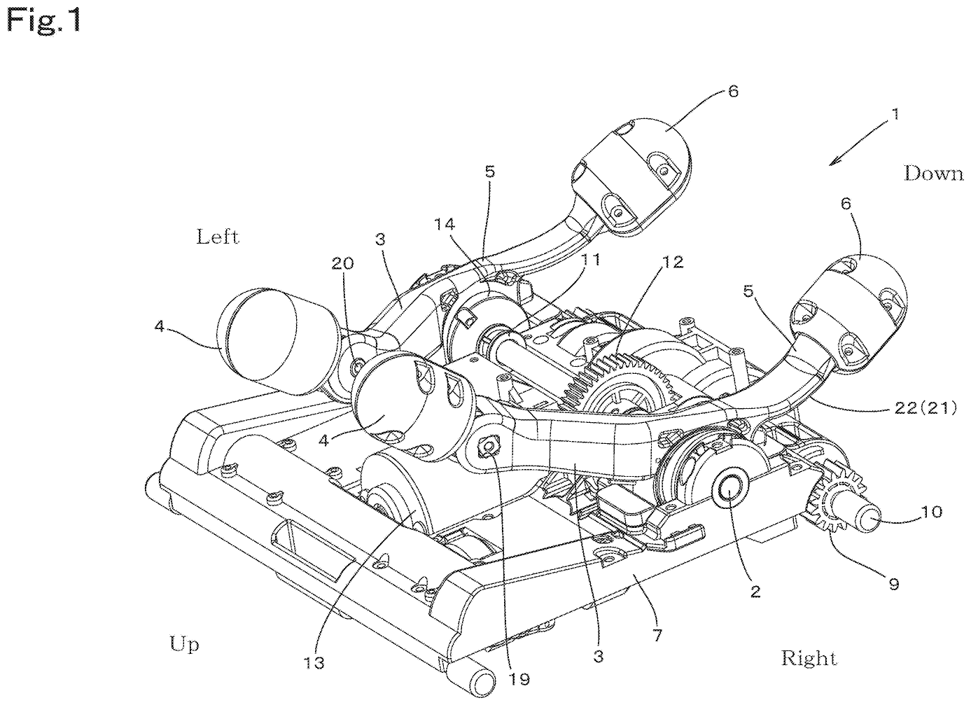

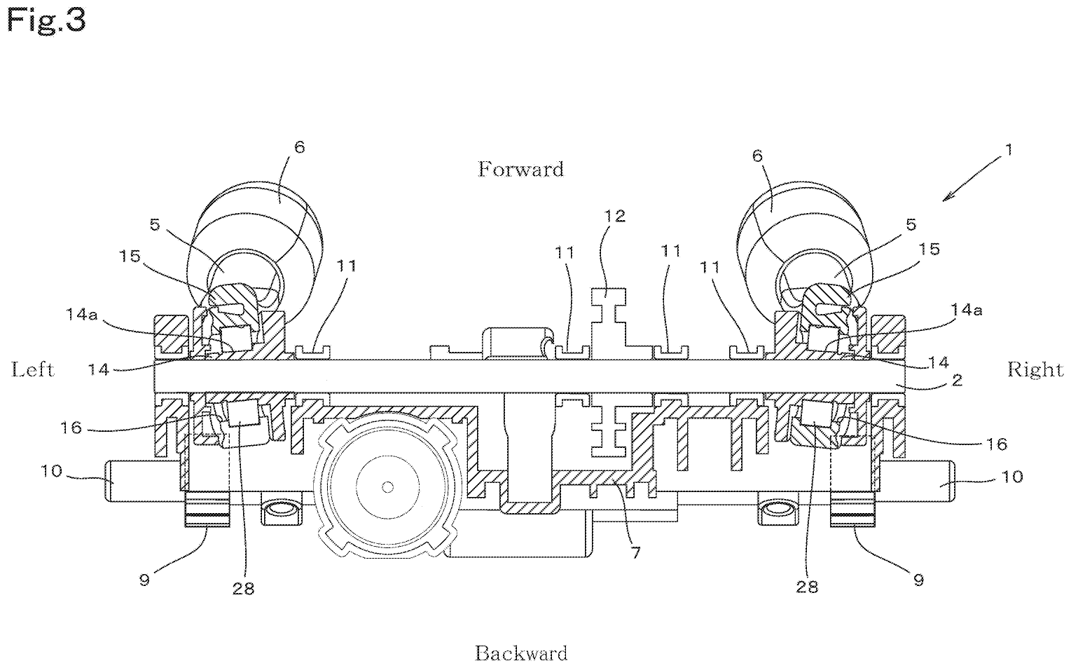

FIGS. 1 to 5 are drawings schematically showing the massaging apparatus 1 according to the first embodiment.

The massaging apparatus 1 according to the first embodiment is mounted in a backrest or a seat of a chair massager, and is also mountable in other types of massagers such as a seat massager, for performing massage treatment on the shoulder, back, waist, buttocks, thigh, etc. of a person who receives massage treatment, i.e. a massager user. Specifically, for example, the described chair massager, in its backrest and seat, is provided with a built-in guide rail extending along the inclination of the backrest, as well as along the upper surface of the seat, for guiding the described massaging apparatus 1 in movement along the guide rail to reach positions corresponding to user's specific body areas in the shoulder-to-thigh range.

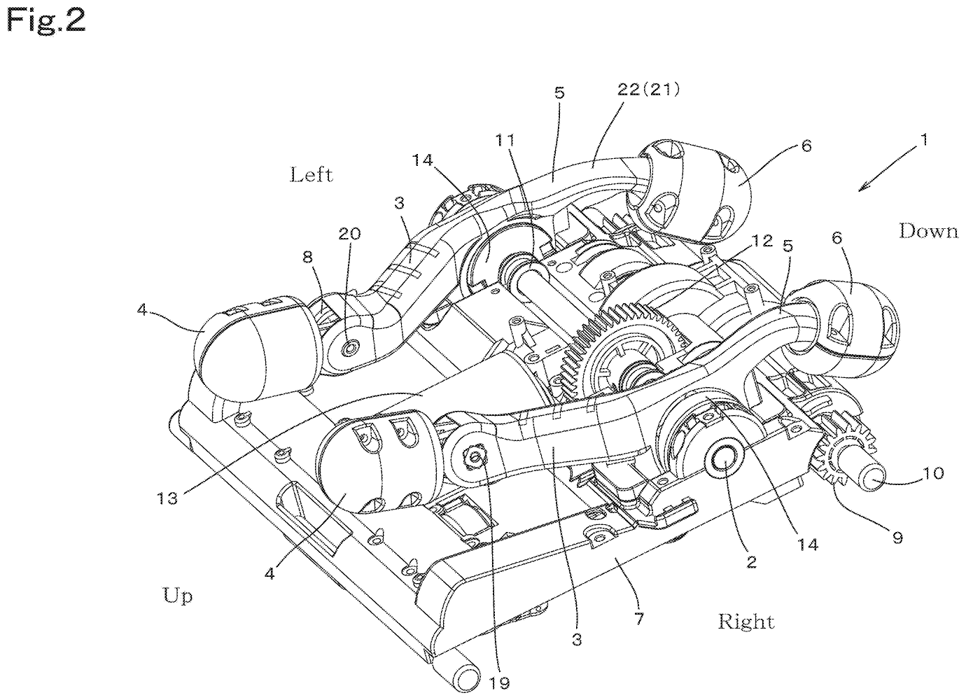

As shown in FIGS. 1 and 2, the massaging apparatus 1 according to the first embodiment comprises: a rotatable drive shaft 2 for producing a driving force for rotation about a horizontally directed axis; a first arm member 3 extending forwardly upwards from the rotatable drive shaft 2; a first massaging element 4 disposed at the head of the first arm member 3; a second arm member 5 extending forwardly downwards from the rotatable drive shaft 2; and a second massaging element 6 disposed at the head of the second arm member 5. The rotatable drive shaft 2, the first arm member 3, the first massaging element 4, the second arm member 5, and the second massaging element 6 are each mounted on a massaging base 7, or more specifically mounted at the front of the massaging base 7. In addition, a spring member 8 is disposed between the first massaging element 4 and the head of the first arm member 3.

The following describes the massaging base 7, the rotatable drive shaft 2, the first arm member 3, the first massaging element 4, the spring member 8, the second arm member 5, and the second massaging element 6 that constitute the massaging apparatus 1 according to the first embodiment.

The constituent components will now be described in accordance with the “FORWARD” and “BACKWARD” positions, the “LEFT” and “RIGHT” positions, and the “UP” and “DOWN” positions, as shown in the drawings, that correspond to the front and rear sides, the left and right sides, and the top and bottom sides, respectively, of the massaging apparatus 1 built into the backrest of a chair massager, as viewed in the eyes of a user (i.e. a person under massage treatment).

The massaging base 7 is a platy member made of, for example, hard plastic or metal. The rear face of the massaging base 7 is provided with an ascent-descent gear 9 for moving the massaging apparatus 1 along the described guide rail, and an ascent-descent shaft 10 for supporting the ascent-descent gear 9 for free rotation about a horizontally directed axis. A driving force for rotation, in other words, a rotatably driving force is transmitted from a motor, not shown, to the ascent-descent gear 9. Engagement of the ascent-descent gear 9 (i.e. pinion gear) with the guide rail (i.e. rack gear) permits the movement of the massaging base 7 in the direction of laying of the guide rail.

The massaging base 7, at its central area in the vertical direction which is located somewhat toward the top, is provided with the rotatable drive shaft 2 mounted so as to extend across the width of the massaging base 7 in the horizontal direction.

Specifically, there are provided bearing portions 11 located toward the left side, the right side, and the central part, respectively, of the described massaging base 7. The rotatable drive shaft 2 is supported for free rotation about a horizontally directed axis by the bearing portions 11.

Moreover, the right-side part of the rotatable drive shaft 2 is provided with a worm wheel 12 for transmitting a rotatably driving force to the rotatable drive shaft 2. A rotatably driving force produced by a motor 13 for kneading massage, in other words, a kneading-massage motor 13 situated toward the top of the massaging base 7 is transmitted to the worm wheel 12 via a worm gear, so that the rotatable drive shaft 2 can rotate about a horizontally directed axis.

The rotatable drive shaft 2 additionally carries inclined bosses 14, situated one toward each side of the worm wheel 12 in the horizontal direction, for transmitting the rotating movement of the rotatable drive shaft 2 to the first arm member 3 and the second arm member 5 to impart horizontal rocking motion to these arm members 3 and 5. The described inclined boss 14 is shaped in a cylinder arranged in coaxial relation to the rotatable drive shaft 2. The outer periphery of the inclined boss 14 is provided with a cam face 14a which moves around an axis inclined with respect to the axis of the rotatable drive shaft 2. An annular fitting 15 is loosely fitted to the exterior of the cam face 14a via a bearing 28.

The annular fitting 15, which is disposed at the base ends of the first arm member 3 and the second arm member 5, includes a hole 16 which fits the cam face 14a of the described inclined boss 14. Moreover, the upper part (i.e. left-side part, as viewed in the drawing) of the annular fitting 15 is provided with a rotational movement-restraining pin 17 protruding upward (i.e. leftward, as viewed in the drawing). There are provided two rotational movement-restraining pins 17 aligned in the front-rear direction, between which is interposed a drive shaft 18 for tapping massage, in other words, a tapping-massage drive shaft 18. The placement of the tapping-massage drive shaft 18 between the two rotational movement-restraining pins 17 restrains the annular fitting 15 from rotating concurrently with the rotation of the rotatable drive shaft 2.

Thus, as the inclined boss 14 moves around a horizontally directed axis in sync with the rotation of the described rotatable drive shaft 2, the annular fitting 15 loosely fitted via the bearing 28 to the cam face 14a of the inclined boss 14 is going to rotationally move in response to the rotational movement of the inclined boss 14. At this time, however, the annular fitting 15, being restrained against rotational movement by the described rotational movement-restraining pins 17, will not rotationally move concurrently with the rotation of the rotatable drive shaft 2. Meanwhile, the described cam face 14a undergoes side-to-side meandering motion over the outer periphery of the inclined boss 14 during its rotational movement, and thus the annular fitting 15 is moved reciprocally only in the horizontal direction while being restrained against concurrent rotational movement. This allows the first arm member 3 and the second arm member 5 each fitted with the annular fitting 15 to rock in the horizontal direction.

The described annular fitting 15 is disposed at each of the left end-side part and the right end-side part of the rotatable drive shaft 2. The cam face 14a fitted to the annular fitting 15 situated toward the left end of the shaft 2 and the cam face 14a fitted to the annular fitting 15 situated toward the right end of the shaft 2 are inclined in opposite directions, that is; the horizontal meandering path of the left end-side cam face 14a is the mirror image of that of the right end-side cam face 14a. Thus, for example, as the left-hand first arm member 3 rocks leftward, the right-hand first arm member 3 rocks rightward, and, on the other hand, as the left-hand first arm member 3 rocks rightward, the right-hand first arm member 3 rocks leftward. This allows the massaging elements 4 of the left-hand and right-hand first arm members 3 and the massaging elements 6 of the left-hand and right-hand second arm members 5 to perform kneading massage treatment on the massage target area lying between a pair of the left-hand first and second arm members 3 and 5 and a pair of the right-hand first and second arm members 3 and 5.

Moreover, the tapping-massage drive shaft 18 interposed between the rotational movement-restraining pins 17 is moved reciprocally in the front-rear direction at short time intervals under a driving force exerted by a motor for tapping massage, in other words, a tapping-massage motor, not shown. This permits tapping massage treatment for the massage target area.

The first arm member 3 is a long rodlike member extending forwardly upwards from the rotatable drive shaft 2. The head of the first arm member 3 has a hollow U-shaped form as seen from in front, and, the U-shaped part has holes 19 formed therethrough in the horizontal direction. A massaging element-rocking shaft 20 is mounted so as to be inserted successively through the left-hand and right-hand through holes 19.

The first massaging element 4 has substantially a cylindrical form with a domical tip. The domical tip is pressed against the massage target area, thereby performing massage treatment on the massage target area. The base end of the first massaging element 4 protrudes toward the massaging base 7 (i.e. protrudes downward). The protruding base end is supported for free rocking motion about a horizontally directed axis by the described massaging element-rocking shaft 20.

The spring member 8 is disposed between the head of the first arm member 3 and the first massaging element 4 as above described. The spring member 8, which is a so-called torsion spring, is wound around the massaging element-rocking shaft 20. The first end of the torsion spring engages the head of the first arm member 3, whereas the second end of the torsion spring engages the first massaging element 4. That is, the spring member 8 is mounted across the head of the first arm member 3 and the first massaging element 4.

Whilst the first massaging element 4 is moved to a forward-bending position, as well as to a backward-bending position, from a neutral position where it extends along the length of the first arm member 3, the spring member 8 effects an urgence tending to restore the first massaging element 4 to the neutral position. Moreover, the first massaging element 4 is pivotally supported by the massaging element-rocking shaft 20 oriented in the horizontal direction, and is thus inhibited from bending in the horizontal direction (i.e. widthwise direction).

In contrast to the first arm member 3, the second arm member 5 extends forwardly downwards from the rotatable drive shaft 2. The second arm member 5 is substantially equal to or slightly smaller in length than the first arm member 3. Like the first arm member 3, the second arm member 5 has the second massaging element 6 disposed at its head. The second arm member 5 is coupled directly to the second massaging element 6 without the massaging element-rocking shaft 20 and the spring member 8 as above described. That is, the second massaging element 6 is non-rockably secured to the second arm member 5.

Like the first massaging element 4, the second massaging element 6 has substantially a cylindrical form with a domical head. The domical head is pressed against the massage target area, thereby performing massage treatment on the target area.

In the massaging apparatus 1 pursuant to the present invention, as described above, the second massaging element 6 is secured, while being restrained against rocking motion, to the second arm member 5 (i.e. non-rockably secured to the second arm member 5). Thus, when the second massaging element 6 is subjected to an excessive load (i.e. weight) caused by the massage target area of user's body approaching from ahead of it, the load cannot be absorbed due to lack of load absorbing means such as a spring member.

In this regard, the massaging apparatus 1 according to the first embodiment incorporates a load-reducing mechanism 21 for reducing a load caused on the massaging system of the apparatus by the second massaging element 6 under an excessive load.

Specifically, the load-reducing mechanism 21 of the first embodiment is designed to absorb a load from the second massaging element 6 by exploiting flexure and deflection of the second arm member 5 in the front-rear direction. That is, the second arm member 5 is constricted at a certain part in the direction of its length to provide a thin-walled portion 22. The thin-walled portion 22 is configured so that its thickness in the front-rear direction is smaller than its width in the horizontal direction when viewed in section.

The following particularizes the load-reducing mechanism 21 which is a striking feature of the first embodiment.

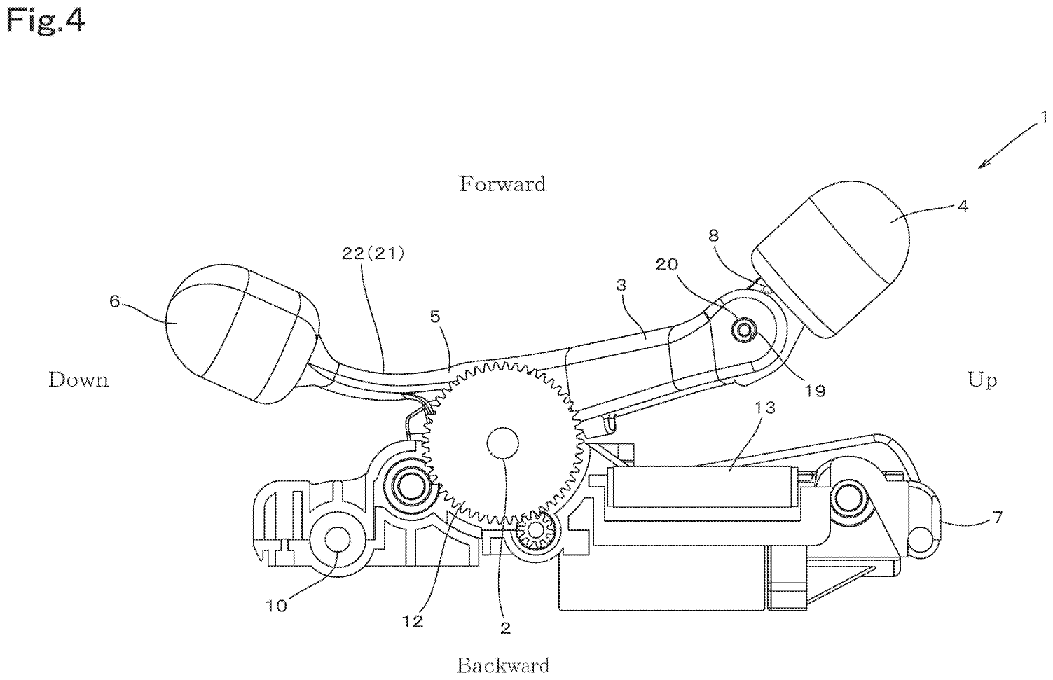

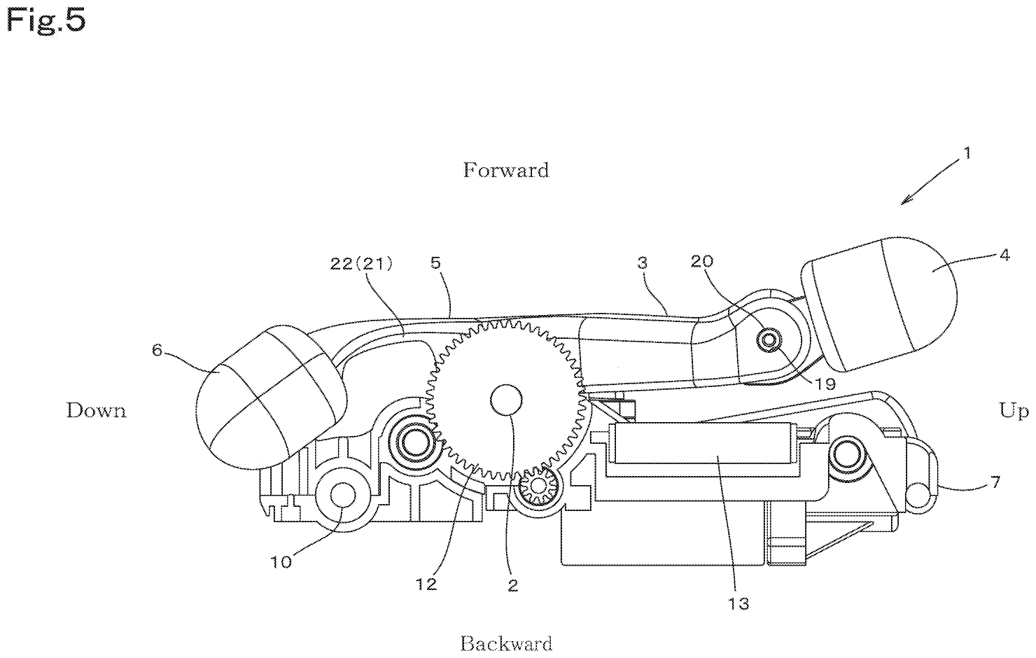

As shown in FIGS. 4 and 5, in the second arm member 5 of the first embodiment, the upper end-side part is shaped in a rectangular prism of substantially the same width and thickness as the first arm member 3, whereas the lower end-side part (i.e. the lower two-thirds of the entire second arm member) constitutes the thin-walled portion 22 having a thickness less than or equal to one-half of the thickness of the first arm member 3.

Specifically, the described thin-walled portion 22 is defined by a certain part of the second arm member 5 in the lengthwise direction. The second arm member 5, in the thin-walled portion 22, is of smaller thickness than in the rest (i.e. other part than the thin-walled portion 22) in the vertical direction. For example, for the case of the first embodiment, the thickness of the thin-walled portion 22 in the front-rear direction is about one-third the thickness of the other part of the second arm member 5 (e.g. one-third the width of the second arm member 5 in the horizontal direction). On the other hand, the first arm member 3 is shaped in a rectangular prism, the width of which in the horizontal direction and the thickness of which in the vertical direction are substantially equal, and is thus almost inflexible.

The described load-reducing mechanism 21 of the first embodiment allows, when the second massaging element 6 is subjected to an excessive load caused by the massage target area of user's body approaching from ahead of it, the second arm member 5 to deflect backward at and around the thin-walled portion 22 for absorption of the load.

Specifically, for example, the described load-reducing mechanism 21 operates in the following manner to achieve load reduction.

As shown in FIG. 4, let it be assumed that the massaging apparatus 1 is in a no-load condition where the first massaging element 4 and the second massaging element 6 are each out of contact with the massage target area of user's body without a load.

In the massaging apparatus 1 in a no-load condition as shown in FIG. 4, the first arm member 3 is in a position where it extends forwardly upwards from the rotatable drive shaft 2, and the second arm member 5 is in a position where it extends forwardly downwards from the rotatable drive shaft 2. Moreover, the first massaging element 4 is in a position where it protrudes forwardly upwards from the head of the first arm member 3, and the second massaging element 6 is in a position where it protrudes forwardly downwards from the head of the second arm member 5.

In the massaging apparatus 1 under the described conditions, as the massage target area of user's body is pressed firmly against the first massaging element 4 and the second massaging element 6, the massaging elements are subjected to a heavy load (i.e. weight) applied from ahead of them.

Upon application of the load, as shown in FIG. 5, the first massaging element 4 is rocked backward about the massaging element-rocking shaft 20. In response to the backward rocking motion of the first massaging element 4, the spring member 8 exerts resiliency for absorption of the load imposed on the first massaging element 4. That is, the load applied to the first massaging element 4 from ahead of it is absorbed by the spring member 8 in a resiliently deformed state. Moreover, the first massaging element 4 is pivotally supported by the massaging element-rocking shaft 20 oriented in the horizontal direction, and is thus inhibited from bending in the horizontal direction (i.e. widthwise direction). This makes it possible to transmit an adequate force to the massage target area during kneading massage treatment (i.e. the mutually approaching and separating movements of the left-hand and right-hand massaging elements in the horizontal direction), and thereby perform satisfactory massage treatment.

On the other hand, the second massaging element 6, for lack of a spring member, is not able to exploit spring's resilient deformation when subjected to a heavy load (i.e. weight) applied from ahead of it. In this regard, for the second massaging element 6, the second arm member 5 is deflected backward at and around the thin-walled portion 22 to absorb the load.

The bending movement of the second arm member 5 is such that its head is gently bent backwardly downwards relative to its base end. Thus, upon deflection, the second massaging element 6 moves backward beyond the second arm member 5. Such a bending movement (i.e. flexure and deflection) of the second arm member 5 helps absorb the load imposed on the second massaging element 6.

The load-reducing mechanism 21 absorbs a heavy load caused on the second massaging element 6 by the massage target area of user's body which is being firmly pressed in contact with the second massaging element 6. That is, the placement of the described load-reducing mechanism 21 eliminates the occurrence of direct load or shock in the massaging system. Thus, the massaging apparatus 1 according to the present embodiment reduces damage to the massaging system, and also prevents the massaging elements (the second massaging element 6, in particular) from hitting or rubbing the massage target area immoderately during massage treatment to avoid user discomfort.

The second arm member 5, which is basically bent in the front-rear direction, is bent little in the horizontal direction. That is, during the horizontal rocking motion of the second arm member 5 to perform kneading massage treatment on the massage target area by the second massaging element 6, the thin-walled portion 22 is deflected little in the horizontal direction, in consequence whereof there results no deformation of the second arm member 5. This allows an adequate kneading force to act on the massage target area.

### Second Embodiment

Next, a massaging apparatus 1 according to the second embodiment of the present invention will be described.

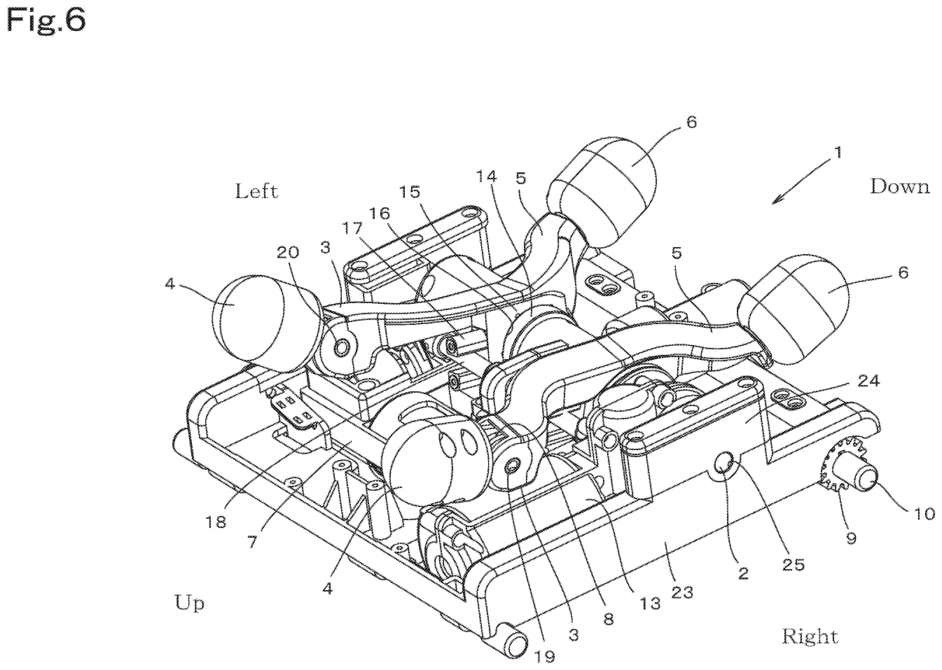

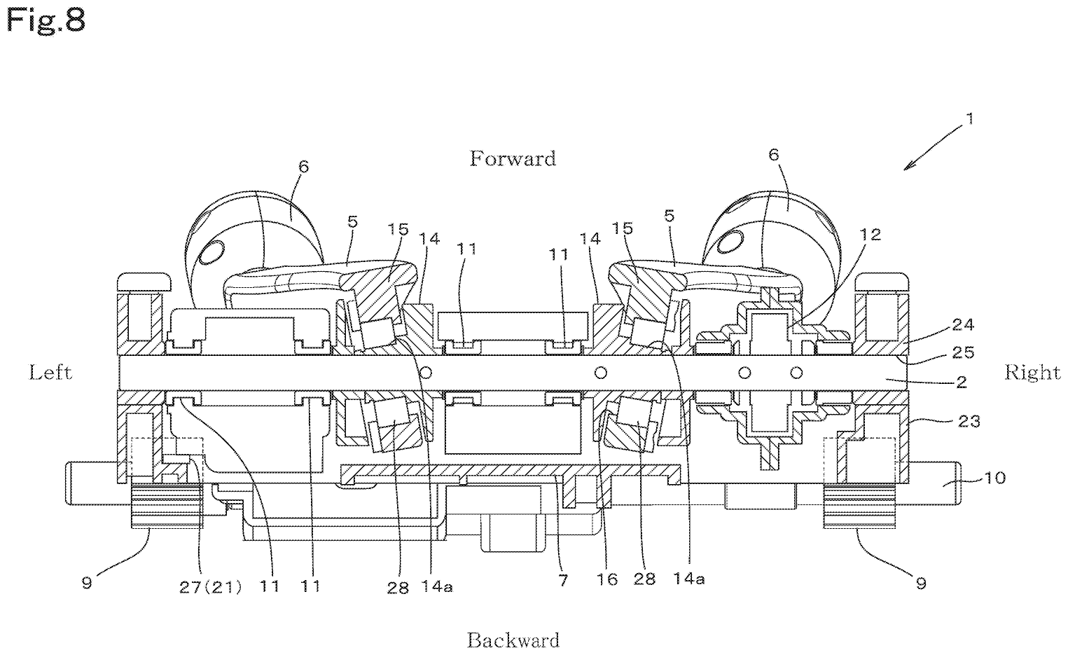

FIGS. 6 to 10 are drawings schematically showing the massaging apparatus 1 according to the second embodiment.

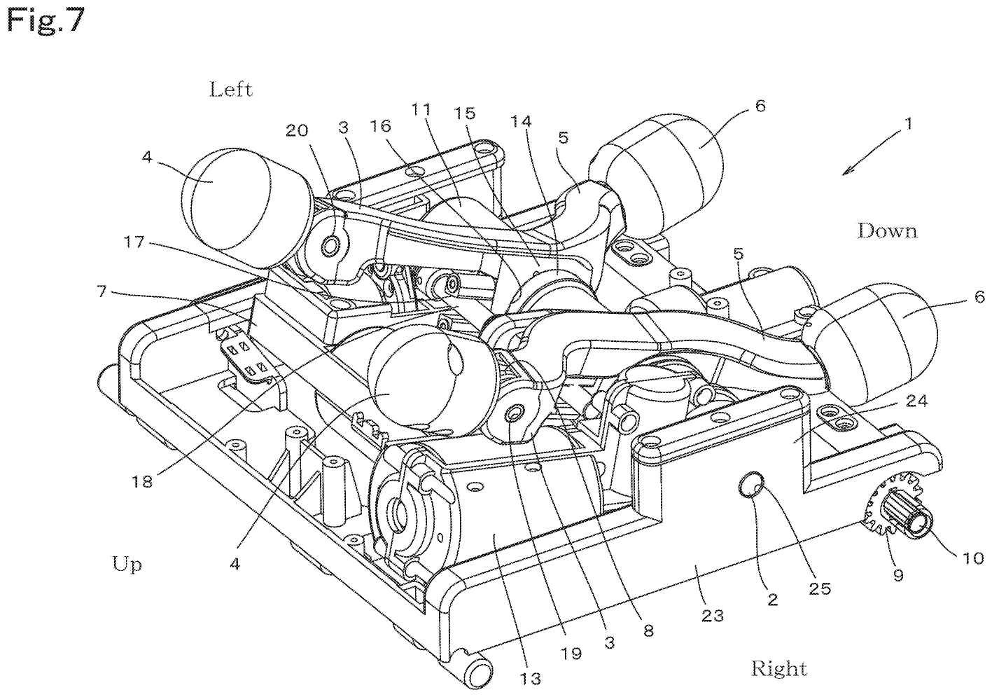

As shown in FIGS. 6 and 7, just as with the first embodiment, the massaging apparatus 1 according to the second embodiment comprises: a rotatable drive shaft 2 for producing a driving force for rotation about a horizontally directed axis; a first arm member 3 extending forwardly upwards from the rotatable drive shaft 2; a first massaging element 4 disposed at the head of the first arm member 3; a second arm member 5 extending forwardly downwards from the rotatable drive shaft 2; and a second massaging element 6 disposed at the head of the second arm member 5.

Just as with the first embodiment, the rotatable drive shaft 2 of the second embodiment additionally carries an inclined boss 14, an annular fitting 15, a rotational movement-restraining pin 17, a tapping-massage drive shaft 18, a kneading-massage motor 13, a tapping-massage motor, etc.

In addition, a spring member 8 is disposed between the head of the first arm member 3 and the first massaging element 4 in much the same fashion as the first embodiment.

A distinct characteristic of the second embodiment is the configuration of its load-reducing mechanism 21.

The load-reducing mechanism 21 of the second embodiment differs from the load-reducing mechanism 21 of the first embodiment in that, in the massaging apparatus 1 according to the second embodiment, the urgence of the described spring member 8 (i.e. the spring member 8 disposed at the head of the first arm member 3) is transmitted to the second massaging element 6 through the first arm member 3 and the second arm member 5, so that a load imposed on the second massaging element 6 can be absorbed by the spring member 8 situated toward the first massaging element 4.

Specifically, the load-reducing mechanism 21 provided in the massaging apparatus 1 according to the second embodiment comprises: the described spring member 8; a massaging base 7 bearing the first arm member 3 and the second arm member 5; and a frame body 23 for supporting the massaging base 7 for rocking motion about a horizontally directed axis at a predetermined rock angle.

That is, the massaging apparatus 1 according to the second embodiment includes the massaging base 7 for supporting the first arm member 3, the second arm member 5, etc., and the frame body 23 for pivotally supporting the massaging base 7 for free rocking motion about a horizontal axis.

The following describes the spring member 8, the massaging base 7, and the frame body 23 that constitute the load-reducing mechanism 21 of the second embodiment.

As shown in FIGS. 6 and 7, the frame body 23 provided in the massaging apparatus 1 according to the second embodiment is a member shaped in a rectangular flat frame as seen from above. The frame body 23 has a centrally-located hole (i.e. opening) formed therethrough in the front-rear direction. The described massaging base 7 can be received in this opening. Moreover, the lower part of the frame body 23 is provided with, for example, an ascent-descent drive motor for producing a rotatably driving force, a power transmission section for transmitting the rotatably driving force produced by the ascent-descent drive motor to an ascent-descent shaft 10 (i.e. a worm gear and a worm wheel 12 for ascent and descent), and the ascent-descent shaft 10 which is free to rotate about a horizontally directed axis under the rotatably driving force transmitted to it via the power transmission section.

In addition, upstanding side walls 24 are formed one at each side of the described frame body 23 in the horizontal direction. Each of the left-hand side wall 24 and the right-hand side wall 24 has a shaft hole 25 formed therethrough in the front-rear direction. The rotatable drive shaft 2 is horizontally mounted so as to span the space between the left-hand shaft hole 25 and the right-hand shaft hole 25 for free rotation about a horizontally directed axis.

The massaging base 7 is a platy member made of, for example, hard plastic or metal, the thickness of which in the vertical direction is smaller than the thickness of which in the horizontal direction. The massaging base 7 is of such size as to be received in the described opening of the frame body 23. The front face of the massaging base 7 is provided with the rotatable drive shaft 2, a bearing portion 11 for rotatably supporting the rotatable drive shaft 2, the first arm member 3, the second arm member 5, and a power transmission mechanism for converting the rotatably driving force of the rotatable drive shaft 2 into the rocking motion of the first and second arm members 3 and 5 (i.e. a mechanism constructed of the inclined boss 14, the annular fitting 15, the rotational movement-restraining pin 17, etc. as described earlier).

Moreover, the rear face of the massaging base 7 is provided with a kneading-massage motor 13 for rotating the rotatable drive shaft 2, and also a tapping-massage drive shaft 18, a tapping-massage motor, etc. for performing tapping massage treatment.

The described rotatable drive shaft 2 is mounted so as to pass through the massaging base 7 and the frame body 23 consecutively. The massaging base 7 is free to rock about a horizontally directed axis relative to the frame body 23 (i.e. free to rock in the front-rear direction) via the rotatable drive shaft 2. For the case of the second embodiment, the axis of the rocking motion of the massaging base 7 coincides with the axis of the rotatable drive shaft 2. That is, the rotatable drive shaft 2 serves to transmit a driving force for driving the first and second arm members 3 and 5, and also to support the massaging base 7 for free rocking motion in the front-rear direction relative to the frame body 23.

The frame body 23 additionally bears a first restraining portion 26, which is contacted by part of the massaging base 7, for restraining the massaging base 7 against forward rocking motion, and a second restraining portion 27, which is contacted by part of the massaging base 7, for restraining the massaging base 7 against backward rocking motion.

The first restraining portion 26 is a member for restraining the massaging base 7 against forward rocking motion through contact with the massaging base 7. In the present embodiment, the first restraining portion 26 restrains the massaging base 7 against forward rocking motion through contact with the upper face of the massaging base 7.

Specifically, the first restraining portion 26 of the present embodiment is disposed on the inner surface of the side wall 24 of the frame body 23, expressed differently, that surface of the side wall 24 opposed to the worm wheel 12 fitted to the rotatable drive shaft 2. The first restraining portion 26 is formed so as to protrude inward in the width direction (i.e. protrude toward the worm wheel 12). The rear face of this protruding portion can be brought into contact with the front face of the massaging base 7.

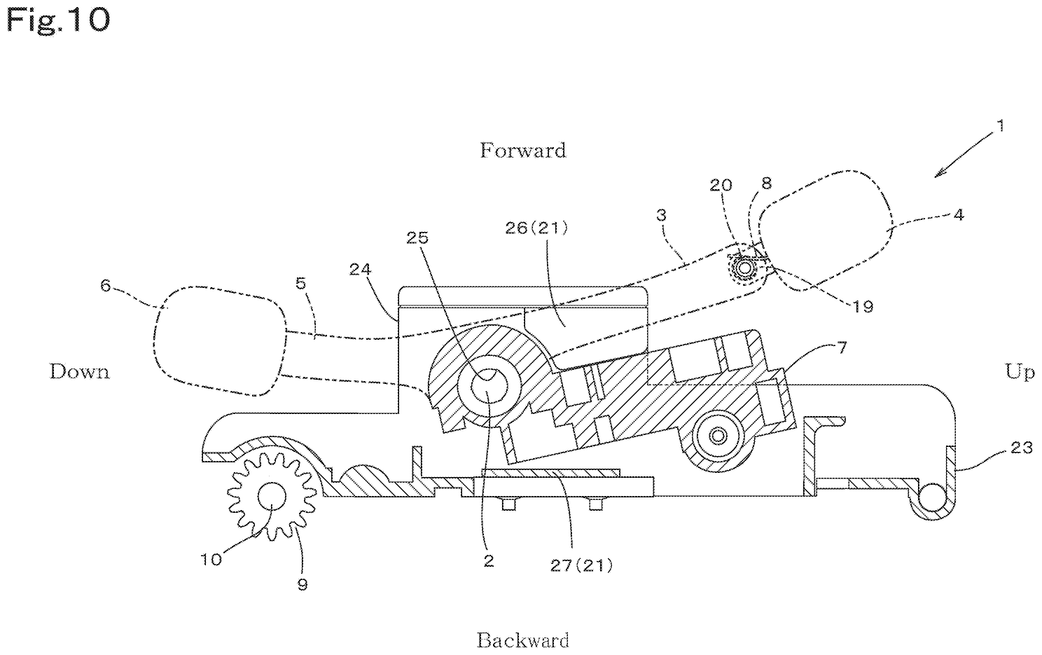

Thus, as shown in FIG. 10, during the forward rocking motion of the massaging base 7 about the axis of the rotatable drive shaft 2 (i.e. during the forward tilt of the first arm member 3), on completion of a forward rock at a predetermined rock angle (e.g. on completion of a 11°-to 12°-angle rock, for the case of this embodiment), the front face of the massaging base 7 is brought into contact with the first restraining portion 26, thereby restraining further forward rocking motion.

The second restraining portion 27 is a member for restraining the massaging base 7 against backward rocking motion through contact with the massaging base 7. In the present embodiment, the second restraining portion 27 restrains the massaging base 7 against backward rocking motion through contact with the rear face of the massaging base 7.

Specifically, the second restraining portion 27 of the present embodiment is a platy member mounted so as to extend across the width of the opening of the frame body 23 (i.e. the rear face of the frame body 23) in the horizontal direction. As the massaging base 7 is rocked backward and then sunk into the frame body 23, the rear face of the massaging base 7 is brought into contact with this platy member.

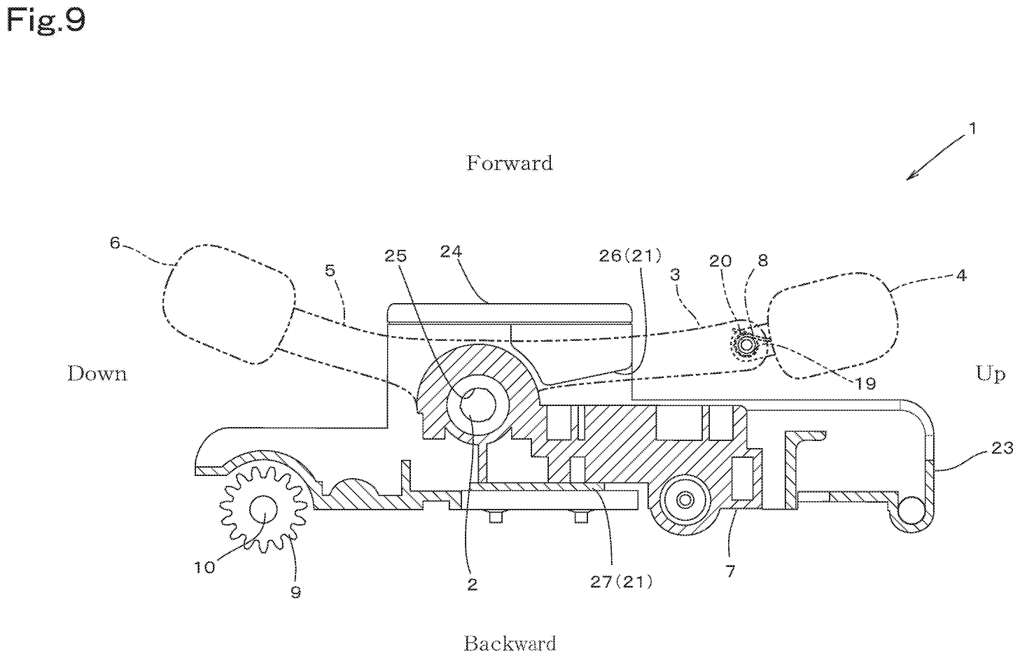

Thus, as shown in FIG. 9, during the backward rocking motion of the massaging base 7 about the axis of the rotatable drive shaft 2, on completion of a backward rock at a predetermined rock angle (e.g. on completion of a rock such that the rear face of the massaging base 7 is vertically oriented, for the case of this embodiment), the rear face of the massaging base 7 is brought into contact with the front face of the second restraining portion 27, thereby restraining further backward rocking motion.

In the load-reducing mechanism 21 of the second embodiment, a heavy load caused on the second massaging element 6 by the massage target area of user's body which is being firmly pressed in contact with the massaging elements (the second massaging element 6, in particular) is transmitted to the spring member 8 disposed near the first massaging element 4, and consequently the spring member 8 becomes resiliently deformed to absorb the load. Thus, the placement of the described load-reducing mechanism 21 eliminates the occurrence of direct load or shock in the massaging system. That is, as the massaging base 7 is rocked back and forth relative to the frame body 23, the heavy load (i.e. weight) imposed on the second massaging element 6 is transmitted to the spring member 8 disposed at the base end of the first massaging element 4 under the rocking motion (i.e. seesaw motion) of the massaging base 7, and, the resilient force of the spring member 8 is reactively transmitted to the second massaging element 6. Thus, the load-reducing mechanism 21 provides the same effects as achieved in a hypothetical case where the spring member 8 is also disposed at the base end of the second massaging element 6. This reduces damage to the massaging apparatus 1. Moreover, even if the massaging elements are pressed firmly against the massage target area of user's body, the first massaging element 4 and the second massaging element 6 can be operated so as to draw back from the massage target area to avoid user discomfort.

It should be understood that the embodiments as disclosed herein are each considered in all respects as illustrative only and not restrictive. In particular, for such matters as not explicitly specified in the disclosure of the embodiment, for example, for working and operating conditions, various parameters, and the dimensions, weights, and volumes of structural components, use has been made of credible values that do not depart from practical ranges adopted in the light of the common knowledge of those skilled in the art.

### REFERENCE SIGNS LIST

1 Massaging apparatus
2 Rotatable drive shaft
3 First arm member
4 First massaging element
5 Second arm member
6 Second massaging element
7 Massaging base
8 Spring member
9 Ascent-descent gear
10 Ascent-descent shaft
11 Bearing portion
12 Worm wheel
13 Kneading-massage motor
14 Inclined boss
14a Cam face
15 Annular fitting
16 Hole
17 Rotational movement-restraining pin
18 Tapping-massage drive shaft
19 Through hole
20 Massaging element-rocking shaft
21 Load-reducing mechanism
22 Thin-walled portion
23 Frame body
24 Side wall
25 Shaft hole
26 First restraining portion
27 Second restraining portion
28 Bearing

1. A massaging apparatus, comprising:
a massaging element for performing massage treatment on a massage target area of user's body; and
an arm member provided at its head with the massaging element,
the arm member having a load-reducing mechanism for absorbing a load applied to the arm member from the massaging element,
the load-reducing mechanism being designed to absorb a load imposed on the massaging element by exploiting an urgence exerted in a front-rear direction.

2. The massaging apparatus according to claim 1,
wherein there are provided a rotatable drive shaft for producing a rotatably driving force, a first arm member extending in a first direction in intersecting relation to the rotatable drive shaft, a second arm member extending in a second direction in intersecting relation to the rotatable drive shaft, a first massaging element disposed at a head of the first arm member, and a second massaging element disposed at a head of the second arm member,
and wherein the load-reducing mechanism effects an urgence in the front-rear direction by causing the second arm member to deflect in the front-rear direction.

3. The massaging apparatus according to claim 2,
wherein the second arm member has a thin-walled portion formed at a certain part thereof in a lengthwise direction,
and wherein the thin-walled portion undergoes elastic deformation to yield an urgence.

4. The massaging apparatus according to claim 1,
wherein there are provided a rotatable drive shaft for producing a rotatably driving force, a first arm member extending in a first direction in intersecting relation to the rotatable drive shaft, a second arm member extending in a second direction in intersecting relation to the rotatable drive shaft, a first massaging element disposed at a head of the first arm member, and a second massaging element disposed at a head of the second arm member,
and wherein the load-reducing mechanism, which is disposed between the first arm member and the first massaging element, includes a spring member which is biased about a horizontally directed axis, and a support structure for supporting the arm member for free rocking motion about the rotatable drive shaft.

5. The massaging apparatus according claim 4,
wherein an urgence of the spring member for the first massaging element is transmitted to the second massaging element via the support structure.

6. The massaging apparatus according claim 4,
wherein there are provided a massaging base bearing the first arm member and the second arm member, and a frame body for supporting the massaging base for rocking motion about the rotatable drive shaft at a predetermined rock angle.

7. The massaging apparatus according to claim 2,
wherein there are provided a rotatable drive shaft for producing a rotatably driving force, a first arm member extending in a first direction in intersecting relation to the rotatable drive shaft, a second arm member extending in a second direction in intersecting relation to the rotatable drive shaft, a first massaging element disposed at a head of the first arm member, and a second massaging element disposed at a head of the second arm member,
and wherein the load-reducing mechanism, which is disposed between the first arm member and the first massaging element, includes a spring member which is biased about a horizontally directed axis, and a support structure for supporting the arm member for free rocking motion about the rotatable drive shaft.

8. The massaging apparatus according to claim 3,
wherein there are provided a rotatable drive shaft for producing a rotatably driving force, a first arm member extending in a first direction in intersecting relation to the rotatable drive shaft, a second arm member extending in a second direction in intersecting relation to the rotatable drive shaft, a first massaging element disposed at a head of the first arm member, and a second massaging element disposed at a head of the second arm member,
and wherein the load-reducing mechanism, which is disposed between the first arm member and the first massaging element, includes a spring member which is biased about a horizontally directed axis, and a support structure for supporting the arm member for free rocking motion about the rotatable drive shaft.
